(19) United States
(12) Patent Application Publication
(10) Pub. No.: US 2013/0087278 A1
(43) Pub. Date: Apr. 11, 2013

(54) METHOD FOR BONDING COMPONENTS BY UTILIZING JOULE HEATING TO CURE CARBON NANOTUBE-EPOXY RESIN COMPOSITE ADHESIVE

(71) Applicants: Shih-Chin Chang, Hsinchu City (TW); Chia-Chi Hsieh, Hsinchu City (TW)

(72) Inventors: Shih-Chin Chang, Hsinchu City (TW); Chia-Chi Hsieh, Hsinchu City (TW)

(73) Assignee: NATIONAL TSING HUA UNIVERSITY

(21) Appl. No.: 13/344,645

(22) Filed: Jan. 6, 2012

(30) Foreign Application Priority Data
Oct. 7, 2011 (TW) 100136440

(51) Int. Cl. B32B 37/06; B32B 37/14; B32B 37/12

(52) U.S. Cl. 156/275.5

(57) ABSTRACT

The using of carbon nanotubes to produce a thin film or buckypaper, hereafter referred to as carbon nanotube membrane, which is soaked with epoxy resin or a carbon nanotube-epoxy resin composite adhesive, and then placed between the joining edges of components, where after an electric current is passed through to heat up the carbon nanotube membrane. This leads to the curing temperature of the epoxy resin or carbon nanotube-epoxy resin composite adhesive, thereby hardening the epoxy resin or carbon nanotube-epoxy resin composite adhesive to achieve bonding. This invention utilizes simple equipment, and the method of an electric current passing through for heating, which can rapidly and uniformly heat the epoxy resin or carbon nanotube-epoxy resin composite adhesive, resulting in hardening and bonding. This method is not affected by the environment, and greatly reduces the time and resources required to harden the epoxy resin, and achieves a stronger effect additionally.

### BACKGROUND OF THE INVENTION

1. Field of the Invention

The present invention relates to a method of bonding components by heating and curing a carbon nanotube-epoxy resin composite adhesive, in particular to a method of bonding components by Joule heating a carbon nanotube membrane to cure the carbon nanotube-epoxy resin composite adhesive.

2. Description of the Related Art

According to conventional technology, there are many ways to bond two or more structures, which can be through polymers, resins, soldering and so on, moreover there are many kinds of adhesives, and the characteristics of the surfaces can be very different, which determines the bonding time and effectiveness of any bond. Epoxy resins have wide applications for fixing and mending in industry.

Compared to mechanical rivets for fixing and mending, epoxy resin already has wide applications in industry for fixing and mending, the production process of using epoxy resin to join items is simple, with less stress concentration, and with no liquid penetration at the joins, or rust corrosion and so on. High strength epoxy resins require a high temperature environment to proceed with curing. Traditionally a heated board, a heated pad, infrared light or a high temperature furnace and so on is used for curing, and the above described methods require that the heat is conducted or radiated from the outside to the adhesive part to cure it. Therefore requiring an extended hardening time, and causing a lot of the heat energy to disperse and be wasted.

In order to reduce the curing time, an epoxy resin body with a copper mesh distributed inside was developed, and electromagnetic induction was used to electrically heat up the copper mesh, thus allowing the epoxy resin to be heated and cured. Although this method greatly reduces the curing time required, the diameter of the copper wire is restricted to 150 microns (currently the thinnest copper wire has a diameter of tens of microns) and with no way to reduce the copper wire to a nanometer scale, the effect of the resulting bond is not good, and tearing easily occurs where the forces are concentrated which weakens the strength of the bond.

Previously microwaves have been used to heat the carbon nanotube-epoxy resin composite adhesive, and this process greatly reduces the curing time, and greatly improves the bonding strength. However the method of using microwaves for curing has several limitations, for example the microwave equipment required is costly, complicated, and is restricted to the areas of the joins where the microwaves can be stably exposed onto. And because this method uses microwaves for heating, it can only be used on substrates which don't reflect or absorb the microwaves and is not practical with materials for bonding which absorb or reflect.

Carbon nanotubes are conductive and can be heated by applying an electric current. When the amount of carbon nanotubes added in a carbon nanotube/epoxy resin composite material exceeds a percolation threshold, the carbon nanotubes-epoxy composite adhesive becomes conductive and can be rapidly heated by allowing electric current to pass through it. However, the conductivity of carbon nanotubes possesses some of the same characteristics as semiconductors. That is, their resistance decreases with an increase of temperature. So, when heated by electric current, if a part of the carbon nanotubes-epoxy composite adhesive is heated more than the other parts, then more current will be concentrated in this part which in turn will generate more heat. This conductivity-temperature positive feedback effect will cause the final burn-out of the carbon nanotubes-epoxy composite adhesive along a narrow path. Therefore, it is not feasible to cure the carbon nanotubes-epoxy composite adhesive layer by applying electric current through leads from two edges of the layer as in the usual way.

Therefore the applicant has focused on the shortcomings in the conventional techniques, to find a more conventional and novel approach for a bonding method, which not only shortens the time required for bonding, but also saves energy, results in an exceptionally strengthened bond and uses basic equipment to complete the task, and therefore invented “method for bonding components by utilizing Joule heating to cure carbon nanotube-epoxy resin composite adhesive” to improve on the above mentioned conventional shortcomings.

### SUMMARY OF THE INVENTION

The purpose of the present invention is to provide a method for bonding components, wherein a carbon nanotube membrane is produced by carbon nanotubes which are soaked with the carbon nanotube-epoxy resin composite adhesive by vacuum filtration method, thereby forming a carbon nanotube membrane with the carbon nanotube-epoxy resin composite adhesive, thereafter placing the carbon nanotube membrane between components to be joined, and passing an electric current to heat the carbon nanotube membrane to reach a curing reaction temperature of the carbon nanotube-epoxy resin composite adhesive, which allows for curing the carbon nanotube-epoxy resin composite adhesive and achieves the effect of joining components.

In order to achieve the above mentioned objective, the present invention provides a method for bonding components by utilizing Joule heating to cure carbon nanotube-epoxy resin composite adhesive, including the following steps: (a) producing a carbon nanotube membrane and a carbon nanotube-epoxy resin composite adhesive; (b) coating the carbon nanotube-epoxy resin composite adhesive or an epoxy composite adhesive on the carbon nanotube membrane; (c) placing the carbon nanotube membrane with the carbon nanotube-epoxy resin composite adhesive between joining surfaces of a plurality of components to be joined; and (d) setting an electrode on two ends of the carbon nanotube membrane respectively, and passing an electric current by adjusting power to heat the carbon nanotube-epoxy resin composite adhesive so as to uniformly conduct heat and to reach a curing temperature for curing the carbon nanotube-epoxy resin composite adhesive.

Preferably, the carbon nanotube-epoxy resin composite adhesive in step (a) has a content of carbon nanotubes occupying a percentage of weight of 0˜6 wt %.

Preferably, the carbon nanotube-epoxy resin composite adhesive in step (a) is a high-temperature solidification type epoxy resin with hardener added.

Preferably, step (c) further comprises step (c1) of exerting moderate pressure onto the plurality of components.

Preferably, the electric current in step (d) is adjusted according to the size of the carbon nanotube membrane and the curing temperature of the epoxy composite adhesive.

Therefore, the present invention uses simple equipment, utilizing the heat conductivity of the carbon nanotube membrane to rapidly and uniformly heat the epoxy resin or the carbon nanotube-epoxy resin composite adhesive to achieve the effect of solidification and bond the components. The technique of this invention is neither limited by the environment, nor the kinds of components used, thereby effectively reducing the cost of epoxy curing energy and time, and further achieving a strengthened bond, and is therefore a component bonding method with a high value in industry.

The invention, as well as its many advantages, may be further understood by the following detailed description and drawings in which:

### BRIEF DESCRIPTION OF THE DRAWINGS

FIG. 1 is a production flow chart showing one embodiment of the present invention.

FIG. 2 is a schematic diagram showing one embodiment of the invention.

FIG. 3 is a cross sectional view showing one embodiment of the invention.

FIG. 4 is a bonding strength comparative chart showing five adhesives with differing contents of carbon nanotubes respectively heated by three different methods.

### DETAILED DESCRIPTION OF THE INVENTION

The technical characteristics and operation processes of the present invention will become apparent with the detailed description of preferred embodiments. While the invention has been described in terms of various specific embodiments, those skilled in the art will recognize that the invention can be practiced with modification within the spirit and scope of the claims.

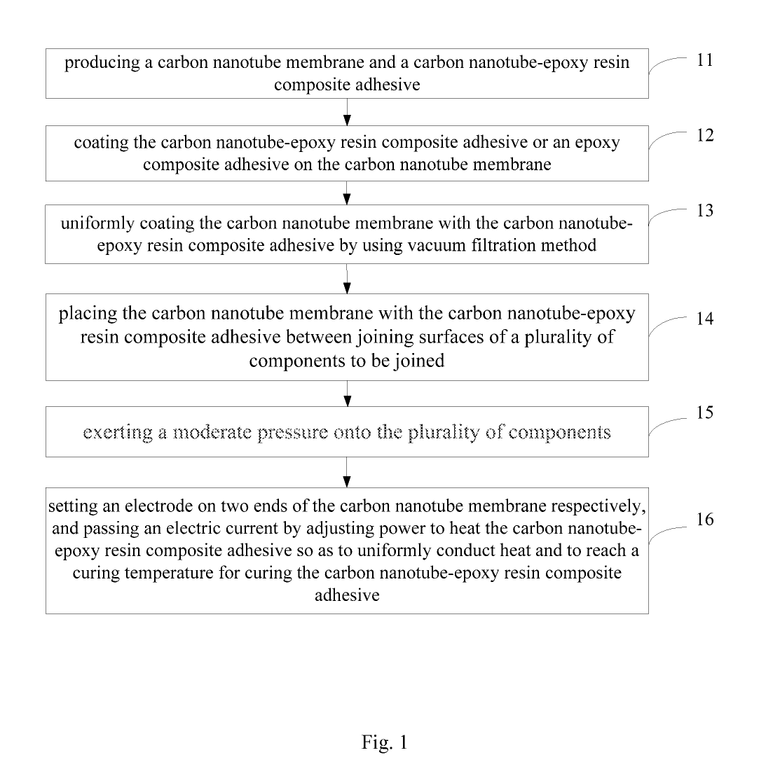

Please refer to FIG. 1, which is a production flow chart showing one embodiment of the present invention. First of all, producing a carbon nanotube membrane and a carbon nanotube-epoxy resin composite adhesive 11, wherein the carbon nanotube membrane is a thin film produced from carbon nanotubes. In this embodiment, the carbon nanotubes-epoxy composite adhesive has a content of carbon nanotubes occupying a percentage of weight of 0˜6 wt %, and the carbon nanotubes-epoxy composite adhesive is a high-temperature solidification type epoxy resin with hardener added; then, coating the carbon nanotube-epoxy resin composite adhesive or epoxy composite adhesive on the carbon nanotube membrane 12, and at the same time the carbon nanotube-epoxy resin composite adhesive uniformly seeps into the carbon nanotube membrane by a vacuum filtration method 13.

Thereafter, placing the carbon nanotube membrane with the carbon nanotube-epoxy resin composite adhesive between joining surfaces of a plurality of components to be joined 14, then exerting a moderate pressure onto the plurality of components 15; finally, setting an electrode on two ends of the carbon nanotube membrane respectively, and passing an electric current by adjusting the power to heat the carbon nanotube-epoxy resin composite adhesive so as to conduct the heat to reach a curing temperature for curing the carbon nanotube-epoxy resin composite adhesive 16, and the electric current is adjusted according to the size of the carbon nanotube membrane and the curing temperature is determined by the epoxy composite adhesive. The needed curing time is less than 20 minutes. In one embodiment with a 1×1 cm² carbon nanotube membrane-epoxy composite adhesive, the composite adhesive can be heated to 150° C. in 8 minutes when 3.76 W of power is applied. The time can be reduced to 4 minutes if the power applied is increased to 4.58 W. To cure the composite adhesive completely, the curing temperature must be maintained for approximately 20 minutes. So, by using the carbon nanotube membrane-epoxy composite adhesive and electrical heating method, the total time for the epoxy to be completely cured is reduced by 60 minutes compared to conventional methods, or by 30 minutes when using microwaves for heating. Since almost all the applied electrical energy is used in curing, this process consumes less energy than any previous heating process. It is estimated that to cure a 1 cm×1 cm×110 μm carbon nanotube membrane-epoxy composite adhesive in this embodiment, the energy needed for bonding is less than 7.5 K Joule.

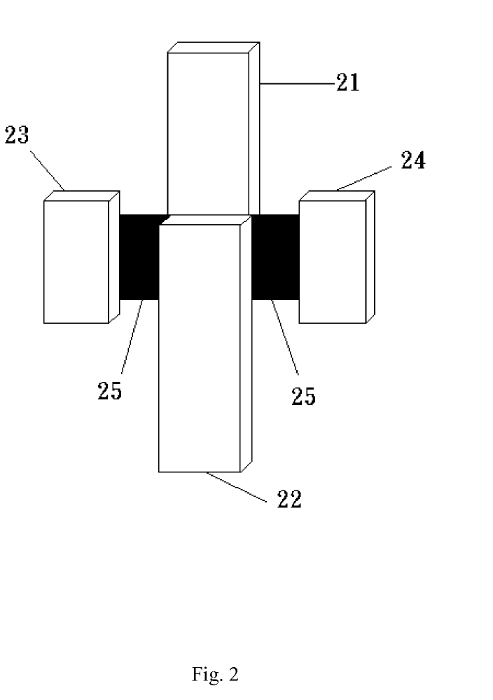

Please refer to FIG. 2, which is a schematic diagram showing one embodiment of the invention. As shown in this figure, a carbon nanotube membrane 25 is soaked with a carbon nanotube-epoxy resin composite adhesive, and which is then placed between the junction of two fiber-reinforced polymer composite materials (FRP) 21 and 22, and when an electric current is passed through for heating, the electric current flows from one electrode 23 or 24 through the carbon nanotube membrane 25 soaked with carbon nanotube-epoxy resin composite adhesive, to the other electrode 24 or 23. Consequently, the carbon nanotube membrane 25 soaked with the carbon nanotube-epoxy resin composite adhesive is heated by the electric current, and after the curing temperature is reached, the two fiber-reinforced polymer composite materials (FRP) 21 and 22 are completely bonded.

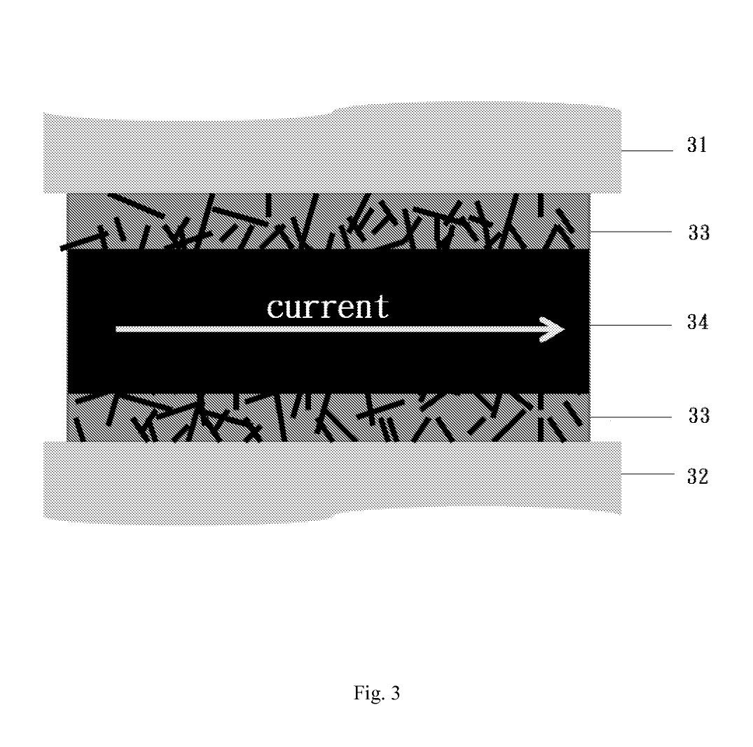

Please refer to FIG. 3, which is a cross sectional view showing one embodiment of the invention. As shown in this figure, a carbon nanotube membrane 34 soaked with the carbon nanotube-epoxy resin composite adhesive 33 is situated between the junction of two fiber-reinforced polymer composite materials (FRP) 31 and 32, and when an electric current passes through for heating, the electric current flows into the carbon nanotube membrane 34 to heat and cure the carbon nanotubes-epoxy adhesive 33.

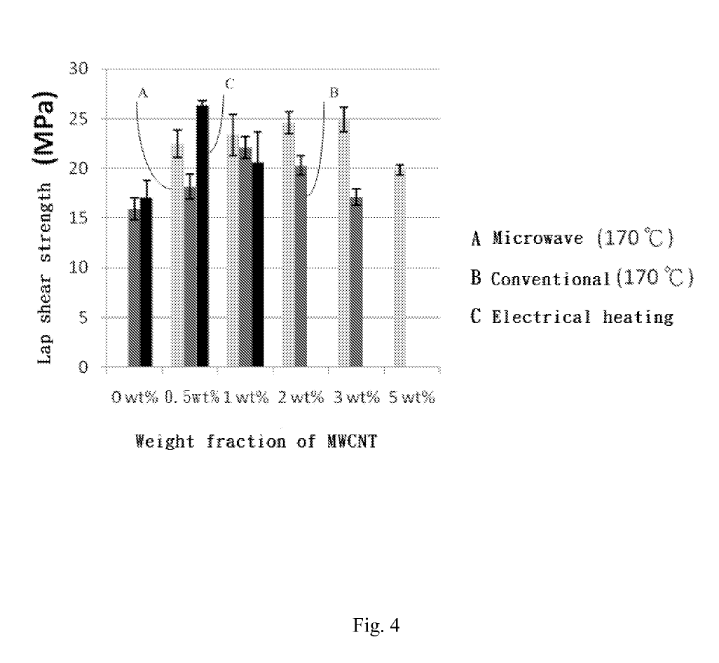

Please refer to FIG. 4, which is a bonding strength comparative chart showing five adhesives with differing contents of carbon nanotubes respectively heated by three different methods. The horizontal axis represents the weight percentage of the multi-layer carbon nanotubes, and the vertical axis represents the bonding strength of each tested adhesive, wherein each adhesive is respectively heated by three different methods, with the different colors A, B and C respectively representing microwave heating, conventional heating and electrical heating. As shown in the figure, the advantage of the present invention is that the achieved bonding strength by Joule heating is larger than those by conventional or microwave heating methods. The single lap shear strength of a sample bonded with pure epoxy cured by conventional heating is 15.9 MPa while that cured by electrical heating with carbon nanotube membrane is 17.0 MPa (a 7% increase). For the samples bonded with 0.5 wt % of CNTs/epoxy, the strengths are 18.1 MPa, 22.5 MPa and 26.7 MPa for conventional, microwave and electrical curing methods respectively. A 48% increase in the strength is achieved by using the electrical curing method.

In summary, the present invention provides a novel method for bonding components without any limitation of their sizes and properties. In effect, the bonding time of this invention is not only less than that of the conventional technique, the bonding material is easily produced, and the cost and the production time are reduced, but also this invention increases the bonding strength and promotes the bonding quality and efficiency of two components.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for bonding components by utilizing Joule heating to cure carbon nanotube-epoxy resin composite adhesive, comprising the following steps:
(a) producing a carbon nanotube membrane and a carbon nanotube-epoxy resin composite adhesive;
(b) coating the carbon nanotube-epoxy resin composite adhesive or an epoxy composite adhesive on the carbon nanotube membrane;
(c) placing the carbon nanotube membrane with the carbon nanotube-epoxy resin composite adhesive between joining surfaces of a plurality of components to be joined; and
(d) setting an electrode on two ends of the carbon nanotube membrane respectively, and passing an electric current by adjusting power to heat the carbon nanotube-epoxy resin composite adhesive so as to uniformly conduct heat and to reach a curing temperature for curing the carbon nanotube-epoxy resin composite adhesive.

2. The method of claim 1, wherein the carbon nanotube membrane in step (a) is a thin film produced by carbon nanotubes.

3. The method of claim 1, wherein the carbon nanotubes-epoxy composite adhesive in step (a) has a content of carbon nanotubes occupying a percentage of weight of 0˜6 wt %.

4. The method of claim 1, wherein the carbon nanotubes-epoxy composite adhesive in step (a) is a high-temperature solidification type epoxy resin with hardener added.

5. The method of claim 1, wherein step (b) further comprises step (b1) of uniformly coating the carbon nanotube membrane with the carbon nanotube-epoxy resin composite adhesive by using vacuum filtration method.

6. The method of claim 1, wherein step (c) further comprises step (c1) of exerting a moderate pressure onto the plurality of components.

7. The method of claim 1, wherein the electric current in step (c) is adjusted according to the size of the carbon nanotube membrane and the curing temperature of the epoxy composite adhesive.
